(19) United States
(12) Patent Application Publication
(10) Pub. No.: US 2005/0069295 A1
(43) Pub. Date: Mar. 31, 2005

(54) Apparatus and method for displaying audio and video data, and storage medium recording thereon a program to execute the displaying method

(75) Inventors: Du-il Kim, Suwon-si (KR); Young-yoon Kim, Seoul (KR); Vladimir Portnykh, Croydon (GB)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/948,316

(22) Filed: Sep. 24, 2004

Related U.S. Application Data
(60) Provisional application No. 60/505,623, filed on Sep. 25, 2003.

(30) Foreign Application Priority Data
Nov. 12, 2003 (KR) 10-2003-0079852

(51) Int. Cl. H04N 5/781

(52) U.S. Cl. 386/95; 386/125

(57) ABSTRACT

An apparatus and a method for displaying audio and video data, and a storage medium for storing the method thereon. The apparatus for displaying audio and video data constituting multimedia data described in MPV format, ascertains whether an asset selected by a user comprises a single video data and at least one or more audio data, extracts reference information to display the video data and the audio data and then displays the extracted video data, using the reference information, and extracts at least one or more audio data from the reference information and then sequentially displays them according to a predetermined method while the video data is being displayed.

This invention claims priority of Korean Patent Application No. 10-2003-0079852 filed on Nov. 12, 2003 in the Korean Intellectual Property Office and U.S. Provisional Patent Application No. 60/505,623 filed on Sep. 25, 2003 in the United States Patent and Trademark Office, the disclosures of which are incorporated herein by reference.

### BACKGROUND OF THE INVENTION

1. Field of Invention

The present invention relates to an apparatus and a method for displaying audio and video data (hereinafter referred to as “AV data”) and a storage medium on which a program to execute the displaying method is recorded, and more particularly to, management of audio and video data among multimedia data in the format of MultiPhotoVideo or MusicPhotoVideo (both of which are hereinafter referred to as “MPV”) and provision of the same to users.

2. Description of the Related Art

MPV is an industrial standard specification dedicated to multimedia titles, published by the Optical Storage Technology Association (hereinafter referred to as “OSTA”), an international trade association established by optical storage makers in 2002. Namely, MTV is a standard specification to provide a variety of music, photo and video data more conveniently or to manage and process the multimedia data. The definition of MPV and other standard specifications are available for use through the official web site (www.osta.org) of OSTA.

Recently, media data comprising digital pictures, video, digital audio, text and the like are processed and played by means of personal computers (PC). Devices for playing the media content, e.g., digital cameras, digital camcorders, digital audio players (namely, digital audio data playing devices such as Moving Picture Experts Group Layer-3 Audio (MP3), Window Media Audio (WMA) and so on) have been in frequent use, and various kinds of media data have been produced in large quantities accordingly.

However, personal computers have mainly been used to manage multimedia data produced in large quantities; in this regard file-based user experience has been requested. In addition, when multimedia data is produced on a specified product, attributes of the data, data playing sequences, and data playing methods are produced depending upon the multimedia data. If they are accessed by the personal computers, the attributes are lost and only the source data is transferred. In other words, there is a very weak inter-operability relative to data and attributes of the data between household electric goods, personal computers and digital content playing devices.

An example of the weak inter-operability will be described. A picture is captured using a digital camera, and data such as the sequence for an attribute slide show, determined by use of a slideshow function to identify the captured picture on the digital camera, time intervals between pictures, relations between pictures whose attributes determined using a panorama function are taken, and attributes determined using a consecutive photoing function are stored along with actual picture data as the source data. At this time, if the digital camera transfers pictures to a television set using an AV cable, a user can see multimedia data whose respective attributes are represented. However, if the digital camera is accessed via a personal computer using a universal serial bus (USB), only the source data is transferred to the computer and the pictures' respective attributes are lost.

As described above, it is shown that the inter-operability of the personal computer for metadata such as attributes of data stored in the digital cameral is very weak. Or, there is no inter-operability of the personal computer to the digital camera.

To strengthen the inter-operability relative to data between digital devices, the standardization for MPV has been in progress.

MPV specification defines Manifest, Metadata and Practice to process and play sets of multimedia data such as digital pictures, video, audio, etc. stored in storage medium (or device) comprising an optical disk, a memory card, a computer hard disk, or exchanged according to the Internet Protocol (IP).

The standardization for MPV is currently overseen by the OSTA (Optical Storage Technology Association) and I3A (International Imaging Industry Association), and the MPV takes an open specification and mainly desires to make it easy to process, exchange and play sets of digital pictures, video, digital audio and text and so on.

MPV is roughly classified into MPV Core-Spec (0.90 WD) and Profile.

The core is composed of three basic factors such as Collection, Metadata and Identification.

The Collection has Manifest as a Root member, and it comprises Metadata, Album, MarkedAsset and AssetList, etc. The Asset refers to multimedia data described according to the MPV format, being classified into two kinds: Simple media asset (e.g., digital pictures, digital audio, text, etc.) and Composite media asset (e.g., digital picture combined with digital audio (StillWithAudio), digital pictures photoed consecutively (StillMultishotSequence), panorama digital pictures (StillPanoramaSequence), etc.). FIG. 1 illustrates examples of StillWithAudio, StillMultishotSequence, and StillPanoramaSequence.

Metadata adopts the format of extensible markup language (XML) and has five kinds of identifiers for identification.
1. LastURL is a path name and file name of a concerned asset (Path to the object),
2. InstanceID is an ID unique to each asset (unique per object: e.g., Exif 2.2),
3. DocumentID is identical to both source data and modified data,
4. ContentID is created whenever a concerned asset is used for a specified purpose, and
5. id is a local variable within metadata.

There are seven profiles: Basic profile, Presentation profile, Capture/Edit profile, Archive profile, Internet profile, Printing profile and Container profile.

MPV supports management of various file associations by use of XML metadata so as to allow various multimedia data recorded on storage media to be played. Especially, MPV supports JPEG (Joint Photographic Experts Group), MP3, WMA(Windows Media Audio), WMV (Windows Media Video), MPEG-1 (Moving Picture Experts Group-1), MPEG-2, MPEG4, and digital camera formats such as AVI (Audio Video Interleaved) and Quick Time MJPEG (Motion Joint Photographic Experts Group) video. MPV specification-adopted discs are compatible with IS09660 level 1, Joliet, and also multi-session CD (Compact Disc), DVD (Digital Versatile Disc), memory cards, hard discs and Internet, thereby allowing users to manage and process more various multimedia data.

However, new formats of various multimedia data not defined in MPV format specification, namely new formats of assets are in need, and an addition of a function to provide the multimedia data is on demand.

### SUMMARY OF THE INVENTION

Accordingly, the present invention is proposed to provide formats of new multimedia data in addition to various formats of multimedia data defined in the current MPV formats, and increase the utilization of various multimedia data by proposing a method to provide multimedia data described according to MPV formats to users in a variety of ways.

According to an exemplary embodiment of the present invention, there is provided an apparatus for displaying audio and video data constituting multimedia data described in MPV format, wherein the apparatus ascertains whether an asset selected by a user comprises a single audio data and at least one or more video data, extracts reference information to display the audio data and the video data and then displays the audio data extracted, by use of the reference information, and extracts at least one or more video data from the reference information and then sequentially displays them according to a predetermined method while the audio data is being output. The displaying operation may allow the video data to be displayed according to information on display time to determine the playback times of respective video data while the audio data is being displayed and information on volume control to adjust the volume generated when the audio data and the video data are being played.

According to another exemplary embodiment of the present invention, there is provided an apparatus for displaying audio and video data constituting multimedia data described in MPV format, wherein the apparatus ascertains whether an asset selected by a user comprises a single video data and at least one or more audio data, extracts reference information to display the video data and the audio data and then displays the video data extracted; using the reference information, and extracts at least one or more audio data from the reference information and then sequentially displays them according to a predetermined method while the video data is being displayed. The displaying method may allow the audio data to be displayed according to information on display time to determine the playback times of respective audio data while the video data is being displayed and information on volume control to adjust the volume generated when the audio data are being played.

According to a further exemplary embodiment of the present invention, there is provided a method for displaying audio and video data constituting multimedia data described in MPV format, comprising ascertaining whether an asset selected by a user comprises a single audio data and at least one or more video data, extracting reference information to display the audio data and the video data, extracting and displaying the audio data using the reference information, and extracting and sequentially displaying at least one or more video data from the reference information according to a predetermined method while the audio data is being displayed.

The displaying method may allow the video data to be displayed according to information on display time to determine the playback times of respective video data while the audio data is being displayed and information on volume control to adjust the volume generated when the audio data and the video data are being played. At this time, the display time information may comprise information on start time when the video data starts to be played and information on playback time to indicate the playback time of the video data.

The extraction and sequential display step comprises synchronizing first time information to designate the time for playing the audio data and second time information to designate the time for playing the at least one or more video data, extracting first volume control information to adjust the volume generated while the audio data is being played and second volume control information to adjust the volume while the at least one or more video data are being displayed, and supplying the audio data and the video data through a display medium by use of the time information and the volume control information.

According to a still further exemplary embodiment of the present invention, there is provided a method for displaying audio and video data constituting multimedia data described in MPV format, comprising ascertaining whether an asset selected by a user comprises single video data and at least one or more audio data, extracting reference information to display the video data and the audio data, extracting and displaying the video data using the reference information, and extracting and sequentially displaying at least one or more audio data from the reference information according to a predetermined method while the video data is being displayed.

The displaying method may allow the audio data to be output according to information on display time to determine the playback times of respective audio data while the video data is being displayed and information on volume control to adjust the volume generated when the video data and the audio data are being played. At this time, the display time information may comprise information on start time when the audio data starts to be played and information on playback time to indicate the playback time of the audio data.

The extraction and sequential display step may comprise synchronizing first time information to designate the time for playing video data and second time information to designate the time for playing the at least one or more audio data, extracting first volume control information to adjust the volume generated while the video data is being played and second volume control information to adjust the volume while the at least one or more audio data are being displayed, and supplying the video data and the audio data through a display medium by use of the time information and the volume control information.

According to a still further exemplary embodiment of the present invention, there is provided a storage medium recording thereon a program for displaying multimedia data described in MPV format, wherein the program ascertains whether an asset selected by a user comprises a single audio data and at least one or more video data, extracts reference information to display the audio data and the video data and then displays the audio data extracted, using the reference information, and extracts at least one or more video data from the reference information and then displays them sequentially according to a predetermined method while the audio data is being output.

According to a still further exemplary embodiment of the present invention, there is provided a storage medium recording thereon a program for displaying multimedia data described in MPV format, wherein the program ascertains whether an asset selected by a user comprises a single video data and at least one or more audio data, extracts reference information to display the video data and the audio data and then displays the video data extracted, using the reference information, and extracts at least one or more audio data from the reference information and then sequentially displays them according to a predetermined method while the video data is being displayed.

### BRIEF DESCRIPTION OF THE DRAWINGS

FIG. 1 is an exemplary view illustrating different kinds of assets described in a MPV specification;

FIG. 2 is an exemplary view schematically illustrating a structure of an ‘AudioWithVideo’ asset according to an aspect of the present invention;

FIG. 3 is an exemplary view illustrating a <VideoWithAudioRef> element according to an aspect of the present invention;

FIG. 4 is an exemplary view illustrating an <AudioWithVideoRef> element according to an aspect of the present invention;

FIG. 5 is an exemplary view illustrating a <VideoDurSeq> element according to an aspect of the present invention;

FIG. 6 is an exemplary view illustrating a <StartSeq> element according to an aspect of the present invention;.

FIG. 7 is an exemplary view illustrating a <VideoVolumSeq> element according to an aspect of the present invention;

FIG. 8 is an exemplary view illustrating an <AudioVolume> element according to an aspect of the present invention;

FIG. 9 is an exemplary diagram illustrating a type of an <AudioWithVideo> element according to an aspect of the present invention;

FIG. 10 is an exemplary diagram illustrating a structure of an ‘VideoWithAudio’ asset according to an aspect of the present invention;

FIG. 11 is an exemplary view illustrating an <AudioDurSeq> element according to an aspect of the present invention;

FIG. 12 is an exemplary view illustrating an <AudioVolumeSeq> element according to an aspect of the present invention;

FIG. 13 is an exemplary view illustrating <VideoVolume> element according to an aspect of the present invention;

FIG. 14 is an exemplary diagram illustrating a type of an <VideoWithAudio> element according to an aspect of the present invention;

FIG. 15 is an exemplary view illustrating an AudioRefGroup according to an aspect of the present invention;

FIG. 16 is an exemplary view illustrating a VideoRefGroup according to an aspect of the present invention;

FIG. 17 is a flow chart illustrating a process of playing the ‘AudioWithVideo’ asset according to an aspect of the present invention; and

FIG. 18 is a block diagram of an apparatus for displaying audio and video data, according to an exemplary embodiment of the present invention.

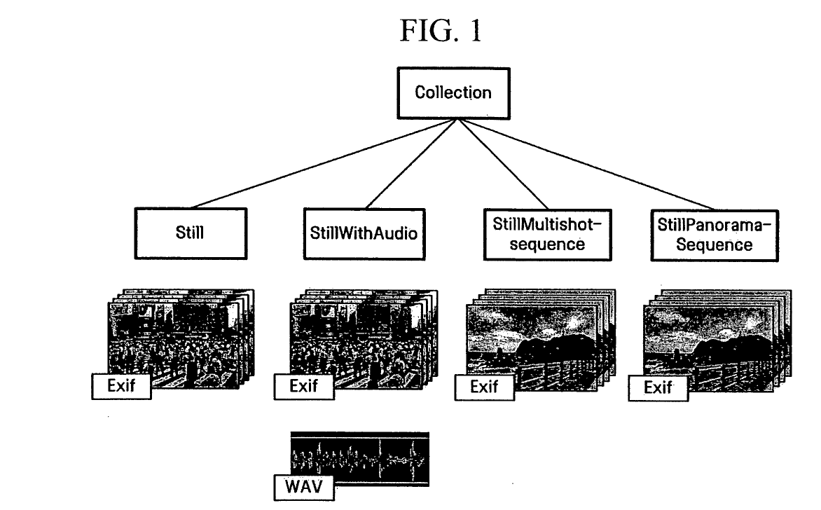

### DETAILED DESCRIPTION OF THE INVENTION

Hereinafter, an apparatus and a method for displaying audio and video data, which are based on MPV formats, according to an aspect of the present invention, will be described in more detail with reference to the accompanying drawings.

In the present invention, XML is used to provide multimedia data according to MPV format. Thus, the present invention will be described according to XML schema.

More various multimedia data are provided herein by proposing new assets of ‘AudioWithVideo’ and ‘VideoWithAudio’ not provided by OSTA. To describe the new assets, the following terms are used: ‘smpv’ and ‘mpv’ refer to a ‘namespace’ in XML, wherein the former indicates a namespace relative to a new element proposed in the present invention and the latter indicates a namespace relative to an element proposed by the OSTA. The definitions and examples of these new assets will be described.

1. AudioWithVideo Asset

This ‘AudioWithVideo’ asset comprises a combination of a single audio asset with at least one or more video assets. To represent this asset in XML, it may be referred to as an element of <AudioWithVideo>. Where a user enjoys at least one or more moving picture contents while listening to a song, this will constitute an example of this asset. At this time, the time interval to play multiple moving picture contents can be controlled, and also the volume from the moving picture contents and that from the song can be controlled.

The audio asset and the video asset are treated as elements in XML documents, that is, XML files. The audio asset may be represented as <smpv:AudioPart> and <mpv:Audio> and the video asset may be represented as <smpv:VideoPart> and <mpv:Video>.

The <AudioPart> element indicates a part of the audio asset. As a sub-element of the <AudioPart>, <SMPV:start>, <SMPV:stop>, <SMPV:dur> can be defined. Among the three sub-elements, a value of at least one sub-element must be designated.

<SMPV:start> sub-element may be defined as <xs:element name=“SMPV:start” type=“xs:long” minOccurs=“0”/>, indicating the start time relative to a part of the entire play time of the audio asset, referenced in the unit of seconds. Given no value thereto, the start time is calculated as in [SMPV:start]=[SMPV:stop]−[SMPV:dur] based on <SMPV:stop> and <SMPV:dur>. Where values of <SMPV:stop> or <SMPV:dur> are not designated, the value of <SMPV:start>is 0.

<SMPV:stop> sub-element may be defined as <xs:element name=“SMPV:stop” type=“xs:long” minOccurs=“0”/>, indicating the stop time relative to a part of the entire play time of the audio asset referenced in the unit of seconds. Given no value thereto, the stop time is calculated as in [SMPV:stop]=[SMPV:start]+[SMPV:dur] based on <SMPV:start> and <SMPV:dur>. Where a value of <SMPV:dur> is not designated but a value of <SMPV:start> is designated, the value of <SMPV:stop> is equal to the stop time of an asset referenced. Where a value of <SMPV:start> is not designated but <SMPV:dur> is designated, the value of <SMPV:stop> is equal to the value of <SMPV:dur>.

<SMPV:dur> sub-element may be defined as <xs:element name=“SMPV:dur” type=“xs:long” minOccurs=“0”/>, indicating the actual play time of the audio asset referenced. Where a value of <SMPV:dur> is not given, this time is calculated as in [SMPV:dur]=[SMPV:stop]−[SMPV:start].

The <VideoPart> element indicates a part of the video asset. The same method of defining the <AudioPart> element can be employed in defining the <VideoPart> element.

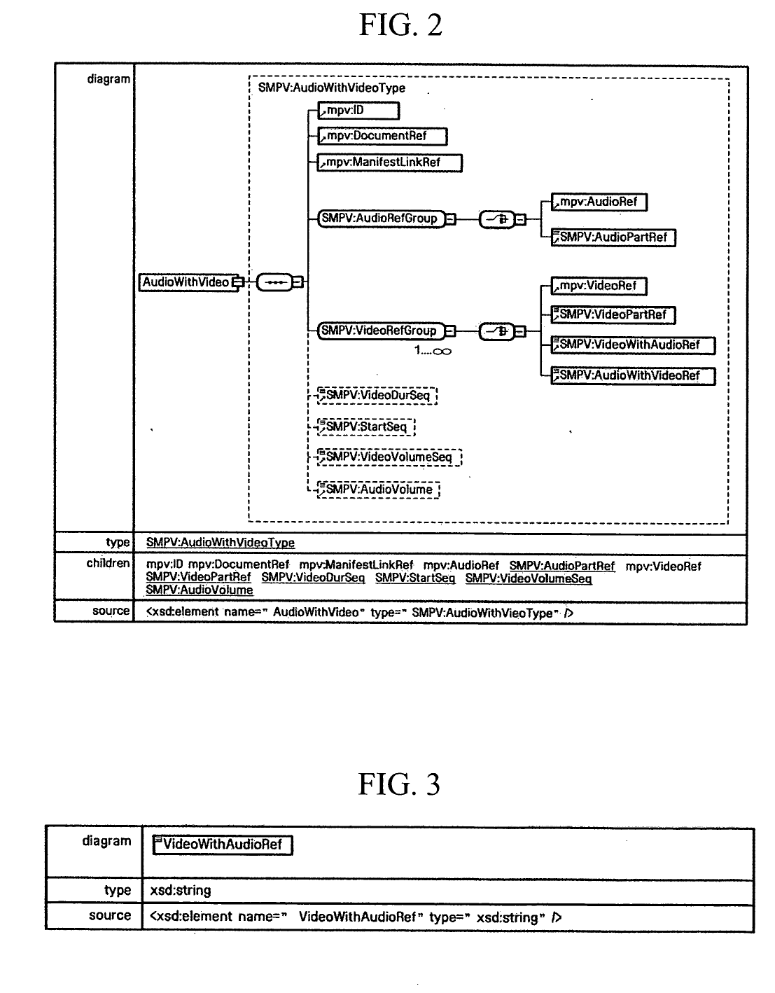

FIG. 2 is an exemplary view schematically illustrating a structure of ‘AudioWithVideo’ asset according to an aspect of the present invention.

Referring to this figure, the <AudioWithVideo> element comprises a plurality of elements respectively having ‘mpv’ or ‘smpv’ as namespace.

Elements having ‘mpv’ as namespace are described in the official homepage of OSTA (www.osta.org) proposing MPV specification, description thereof will be omitted herein. Accordingly, only elements having ‘smpv’ as namespace will be described below.

(1) <AudioPartRef>

This element references the <AudioPart> element.

(2) <VideoPartRef>

This element references the <VideoPart> element.

(3) <VideoWithAudioRef>

This element references the <VideoWithAudio> element, which is illustrated in FIG. 3.

(4) <AudioWithVideoRef>

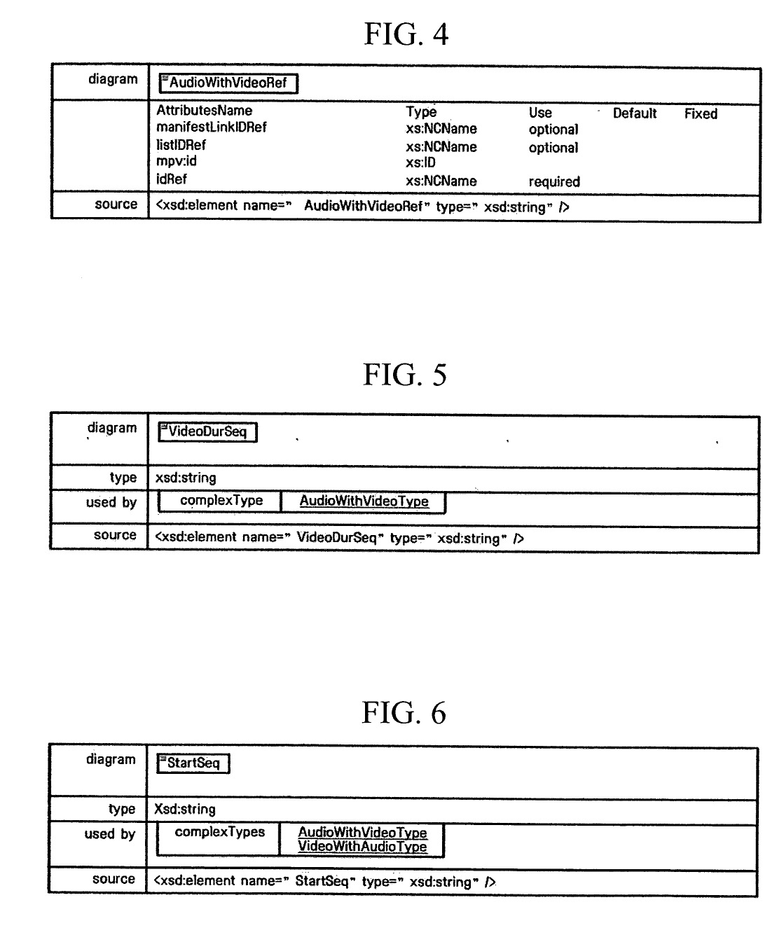

This element references the <AudioWithVideo> element, which is illustrated in FIG. 4.

(5) <VideoDurSeq>

A value of this element indicates the play time of respective video data, being represented in the unit of seconds and indicating a relative time value. The play time may be presented in decimal points. Where a value of this element is not set, it is regarded that the play time is not set, and thus, the total play time of any concerned video data is assumed to be equal to the value of the <VideoDurSeq> element.

The total play time of any concerned video data may be determined depending upon a reference type of the video data referenced in the video asset.

Namely, the total play time of a concerned video data is equal to the total play time of the video data referenced when the reference type is ‘VideoRef.’ Where the reference type is ‘VideoPartRef,’ it is possible to obtain the total play time of the concerned video data using an attribute value of the <VideoPart> element referenced. Where the reference type is ‘AudioPartRef,’ the reference type relative to the audio data should be identified in the referenced <AudioWithVideo> element. To be specific, where the reference type relative to the audio data is ‘AudioRef,’ the total play time of the concerned video data is equal to the total play time of the audio data, and where the reference type relative to the audio data is ‘AudioPartRef,’ the total play time of the concerned video data can be obtained by an attribute value of the referenced <AudioPart> element. Further, where the reference type is ‘VideoWithAudioRef,’ only the video asset is extracted from the <VideoWithAudio> element, and the total play time of the video data referenced as ‘VideoRef’ in the extracted video asset is regarded as the total play time of the concerned video data.

A value of the <VideoDurSeq> element will be described in brief.
VideoDurSeq=<clock-value>(“;”<clock-value>) (1)
clock-value=(<seconds>|<unknown-dur>) (2)
unknown-dur=the empty string (3)
seconds=<decimal number>(.<decimal number>) (4)

Formula (1) means that a value of the <VideoDurSeq> element is represented as ‘clock-value,’ and play times of respective video type are identified by means of “;” where there are two or more video data.

Formula (2) means that ‘clock-value’ in Formula (1) is indicated as ‘seconds’ or ‘unknown-dur.’

Formula (3) means that ‘unknown-dur’ in Formula (2) indicates no setting of ‘clock-value.’

Formula (4) means that ‘seconds’ in Formula (2) is indicated as a decimal and playback time of the concerned video data can be indicated by means of a decimal point.

For example, where ‘clock-value’ is ‘7.2,’ this means that the playback time of the concerned video data is 7.2 seconds. As another example, where ‘clock-value’ is ‘2:10.9,’ this means that there are two video data concerned, one of which is played for 2 seconds and the other of which is placed for 10.9 seconds. As a further example, where ‘clock-value’ is ‘;5.6,’ this means that there are two video data concerned, one of which is played for the total playback time of the concerned content because its playback time is not set, and the other of which is played for 5.6 seconds. FIG. 5 illustrates the <VideoDurSeq> element.

(6) <StartSeq>

A value of <StartSeq> element indicates a point in time when each of video data starts to play back. The point in time is in the unit of seconds, indicating a relative time value based on the start times of the respective video data. The playback start time may be indicated as a decimal point. For example, where a value of the <StartSeq> element is not set, the value is assumed to be 0 seconds. Namely, the concerned video data is played from the playback start time thereof. If the value of <StartSeq> element is larger than the total playback time of the concerned video data, it causes the concerned video data to play after the playback thereof ends: in this case, the value of <StartSeq> element is assumed to be 0.

If <VideoDurSeq> element and <StartSeq> element are both defined within <AudioWithVideo> element, the value of summing <VideoDurSeq> element and <StartSeq> element should be equal to or less than the total playback time of the concerned video data. If not so, the value of <VideoDurSeq> element becomes the deduction of the value of <StartSeq> element from the total playback time of the concerned video data. FIG. 6 illustrates the <StartSeq> element.

(7) <VideoVolumeSeq>

A value of <VideoVolumeSeq> element indicates the volume size of the concerned video data by percentage. Thus, where the value of <VideoVolumeSeq> element is 0, the volume of the concerned video data becomes 0. If the value of <VideoVolumeSeq> element is not set, the concerned video data is played with the volume as originally set.

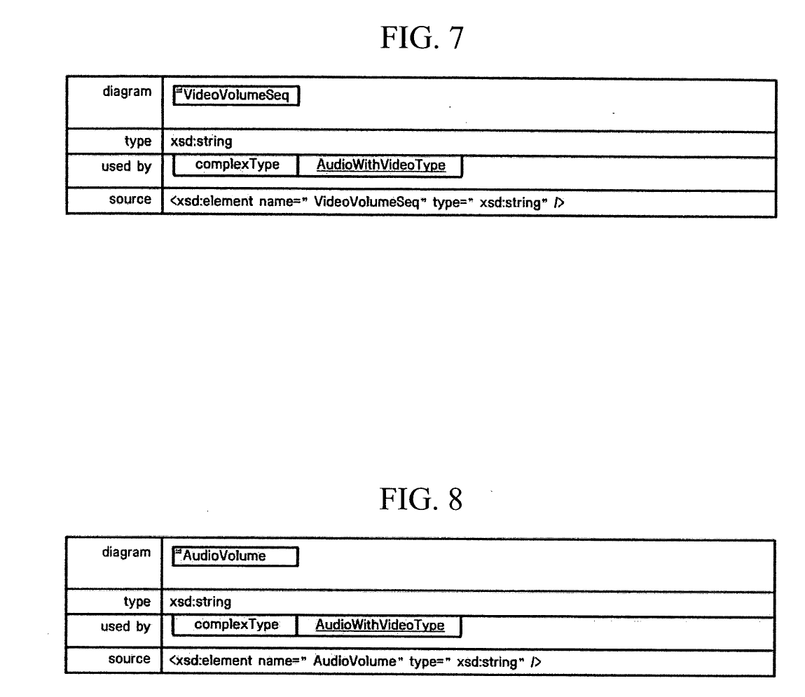

While a plurality of video data are played, values of the <VideoVolumeSeq> element, as many as the played video data, are set. However, if a single value is set, all of the video data played are played with the volume having the single value as set. FIG. 7 illustrates the <VideoVolumeSeq> element.

(8) <AudioVolume>

A value of <AudioVolume> indicates the volume size of the concerned audio data in percentage. When the value of <AudioVolume> element is not set, it is assumed to be 100. FIG. 8 illustrates the <AudioVolume> element.

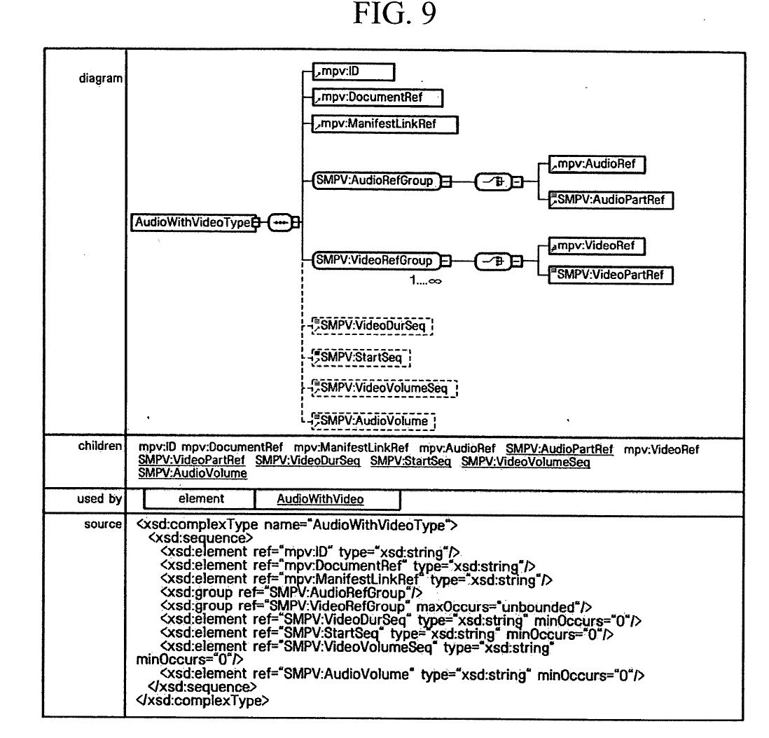

FIG. 9 is an exemplary diagram illustrating a type of an <AudioWithVideo> element according to an aspect of the present invention.

An exemplary method for providing an asset of <AudioWithVideo> using the above-described elements will be described.

### EXAMPLE 1

<SMPV:AudioWithVideo>

<AudioRef>A0007</AudioRef>
<VideoRef>V1205</VideoRef>
<VideoRef>V1206</VideoRef>
<SMPV:StartSeq>;3</SMPV:StartSeq>

</SMPV:AudioWithVideo>

Example 1 illustrates a method of playing the <AudioWithVideo> asset using one audio asset referenced as ‘A0007’ and two video assets referenced as ‘V1205’ and ‘V1206’ respectively. In this example, since a value of <StartSeq> element is not set with respect to the video asset whose value is referenced as ‘V1205,’ the value is assumed to be 0 seconds. Namely, the video asset referenced as ‘V1205’ is being played from the point in time when the audio asset referenced as ‘A0007’ starts to play to the time when the video asset referenced as ‘V1206’ starts to play. Meanwhile, since a value of the <StartSeq> element is set to be 3 with respect to the video asset whose value is referenced as ‘V1206,’ the video asset referenced as ‘V1206’ is being played in three seconds after the point in time when the video asset referenced as ‘V1206’ starts to play.

### EXAMPLE 2

<SMPV:AudioWithVideo>

<AudioRef>A0001</AudioRef>
<VideoRef>V1001</VideoRef>
<VideoRef>V1002</VideoRef>
<VideoRef>V1003</VideoRef>
<SMPV:VideoDurSeq>2;;10</SMPV:VideoDurSeq>
<SMPV:StartSeq>;3;0</SMPV:StartSeq>
<SMPV:VideoVolumeSeq>50</SMPV:VideoVolumeSeq>
<SMPV:AudioVolume>50</SMPV:AudioVolume>

</SMPV:AudioWithVideo>

Example 2 illustrates a method of playing an AudioWithVideo asset using one audio asset referenced as ‘A0001’ and three video assets referenced as ‘V1001,’ ‘V1002’ and ‘V1003’ respectively. In this example, the video asset referenced as ‘V0001’ is played for two seconds. The video asset referenced as ‘V1002’ starts to play after playback of the video asset referenced as ‘V1001’ ends and after three seconds have passed since the video asset referenced as ‘V1001’ starts to play. The video asset referenced as ‘V1003’ is being played for ten seconds after playback of the video asset referenced as ‘V1002’ ends.

The three video assets are played with the volume sizes of 50% of their original volumes, and the audio asset is also played with the volume size of 50% of its original volume.

### EXAMPLE 3

<SMPV:AudioWithVideo>

<AudioRef>A0001</AudioRef>
<VideoPartRef>VP1001</VideoPartRef>
<AudioWithVideoRef>AV1002</AudioWithVideoRef>

</SMPV:AudioWithVideo>

2. ‘VideoWithAudio’ Asset

This ‘VideoWithAudio’ asset comprises a combination of a single video asset with at least one or more audio assets. To represent this asset in XML, it may be referred to as an element of <VideoWithAudio>. The audio asset and the video asset are treated as elements in XML documents. The audio asset may be represented as <smpv:AudioPart> or <mpv:Audio>, and the video asset may be represented as <smpv:VideoPart> or <mpv:Video>.

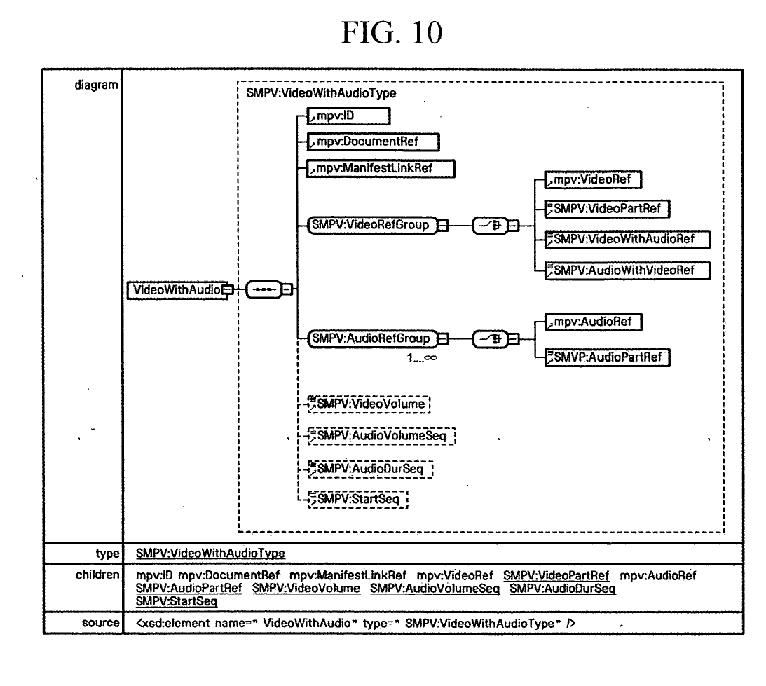

FIG. 10 is an exemplary diagram illustrating a structure of an ‘VideoWithAudio’ asset according to an aspect of the present invention. Referring to a diagram of the <VideoWithAudio> element shown therein, the <VideoWithAudio> Element comprises a plurality of elements respectively having ‘mpv’ or ‘smpv’ as namespace.

Elements having ‘mpv’ as namespace are described in the official homepage of OSTA (www.osta.org) proposing MPV specification, therefore description thereof will be omitted herein. Accordingly, only elements having ‘smpv’ as namespace will be described below. In this regard, since the AudioWithVideo asset has already described herein, duplicated description will be omitted.

(1) <AudioDurSeq>

Values of the <AudioDurSeq> element indicates playback times of the respective audio data. The playback time may be indicated in the unit of seconds, indicating a relative time value. The playback time may be indicated using a decimal point. Where the value of <AudioDurSeq> is not set, it is assumed that the playback time is not set, and the total playback time of the concerned audio data is regarded as the value of <AudioDurSeq> element. A value of the <AudioDurSeq> element will be briefly described.
AudioDurSeq=<clock-value>(“;”<clock-value>) (5)
clock-value=(<seconds>|<unknown-dur>) (6)
unknown-dur=the empty string (7)
seconds=<decimal number>(.<decimal number>). (8)

Formula (5) means that a value of <AudioDurSeq> element is indicated by ‘clock-value,’ and where there are two audio data, respective playback times of the audio data are identified by use of “;”

Formula (6) means that ‘clock-value’ in Formula (5) is indicated in ‘seconds’ or ‘unknown-dur.’

Formula (7) means that ‘unknown-dur’ in Formula (6) indicates no setting of ‘clock-value.’

Formula (8) means that ‘seconds’ in Formula (6) is indicated as a decimal and playback time of the concerned video data can be indicated by means of a decimal point.

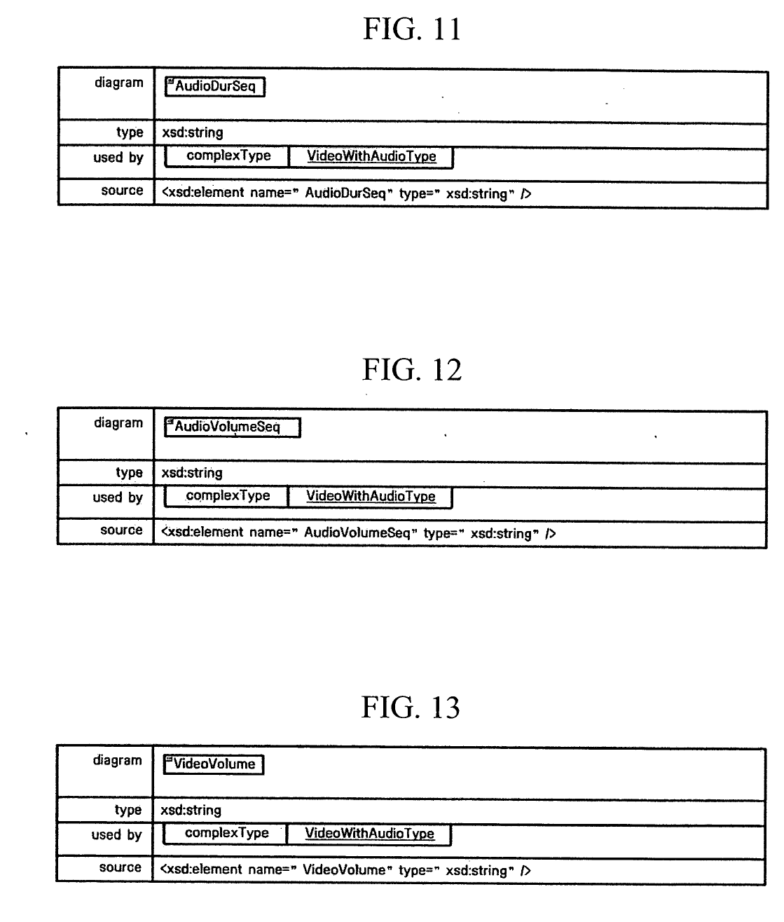

For example, when ‘clock-value’ is ‘12.2,’ this means that the playback time of the concerned audio data is 12.2 seconds. As another example, where ‘clock-value’ is ‘20;8.9,’ this means that there are two audio data concerned, one of which is played for 20 seconds and the other of which is placed for 8.9 seconds. As a further example, where ‘clock-value’ is ‘;56.5’, this means that there are two audio data concerned, one of which is played for the total playback time of the concerned content because its playback time is not set, and the other of which is played for 56.5 seconds. FIG. 11 briefly illustrates the <AudioDurSeq> element.

(2) <AudioVolumeSeq>

A value of the <AudioVolumeSeq> element indicates the volume size of the concerned audio data in percentage. If the value of <AudioVolumeSeq> element is not set, the concerned audio data is played with the volume as originally set.

While a plurality of audio data are played, values of the <AudioVolumeSeq> elements, as many as the played audio data, are set. However, if a single value is set, all of the audio data played are played with the volume having the single value as set. FIG. 12 illustrates the <AudioVolumeSeq> element.

(3) <VideoVolume>

A value of <VideoVolume> indicates the volume size of the concerned video data in percentage. Where the value of <VideoVolume> element is not set, it is assumed to be 100. That is, it is played with the originally set volume of the concerned video data. FIG. 13 briefly describes the <VideoVolume> element.

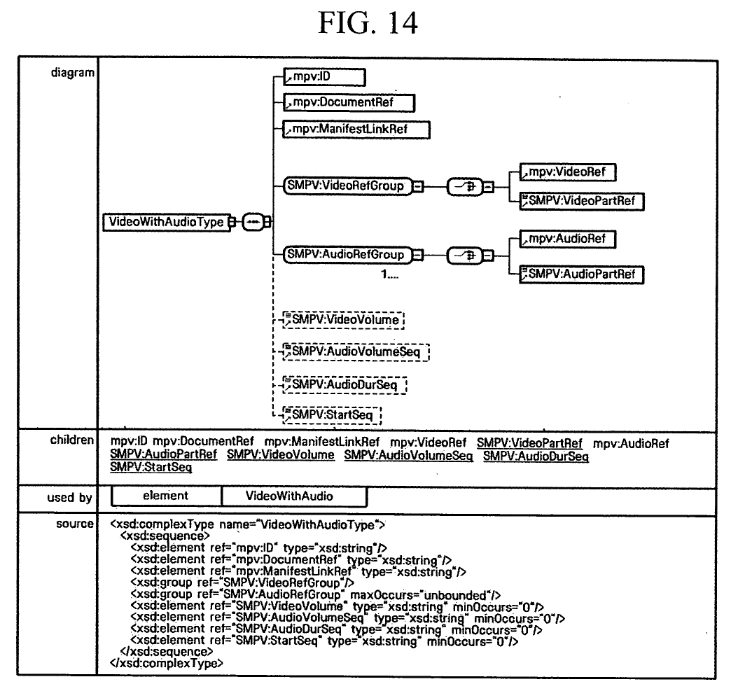

FIG. 14 is an exemplary diagram illustrating a type of a <VideoWithAudio> element according to an aspect of the present invention.

According to an exemplary aspect of the present invention, reference groups for reference of assets may be defined.

‘AudioRefGroup’ to reference audio assets and ‘VideoRefGroup’ to reference video assets may be defined.

At this time, the AudioRefGroup comprises elements of <mpv:AudioRef> and <SMPV:AudioPartRef>.

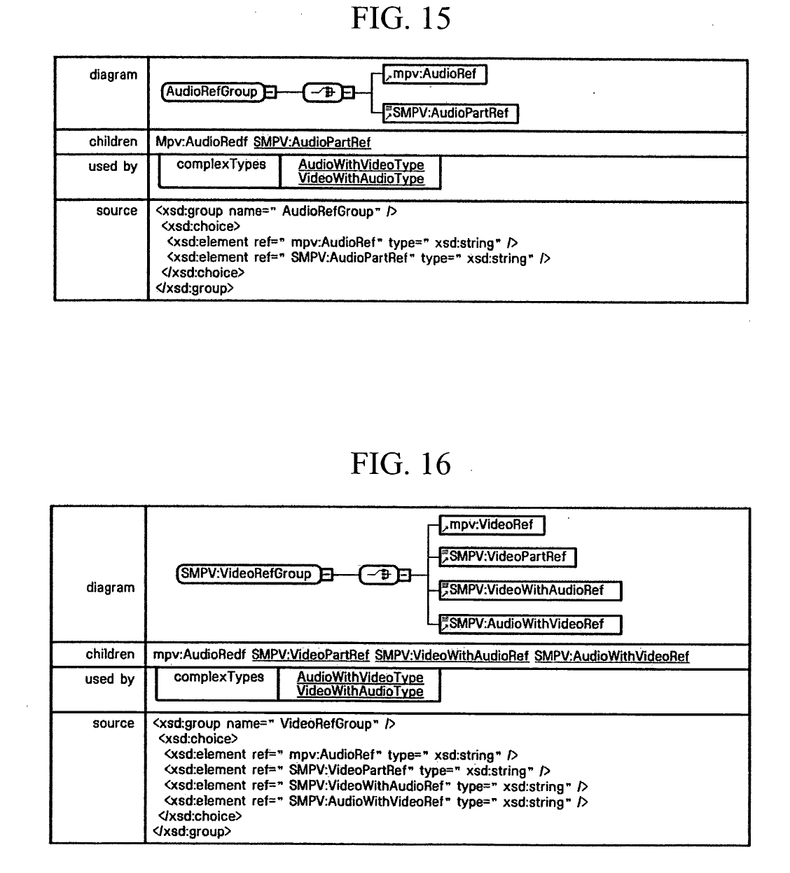

Also, the VideoRefGroup comprises elements of <mpv:VideoRef>, <SMPV:VideoPartRef>, <SMPV:VideoWithAudioRef> and <SMPV:AudioWithVideoRef>. FIGS. 15 and 16 describe the ‘AudioRefGroup’ and the ‘VideoRefGroup.’

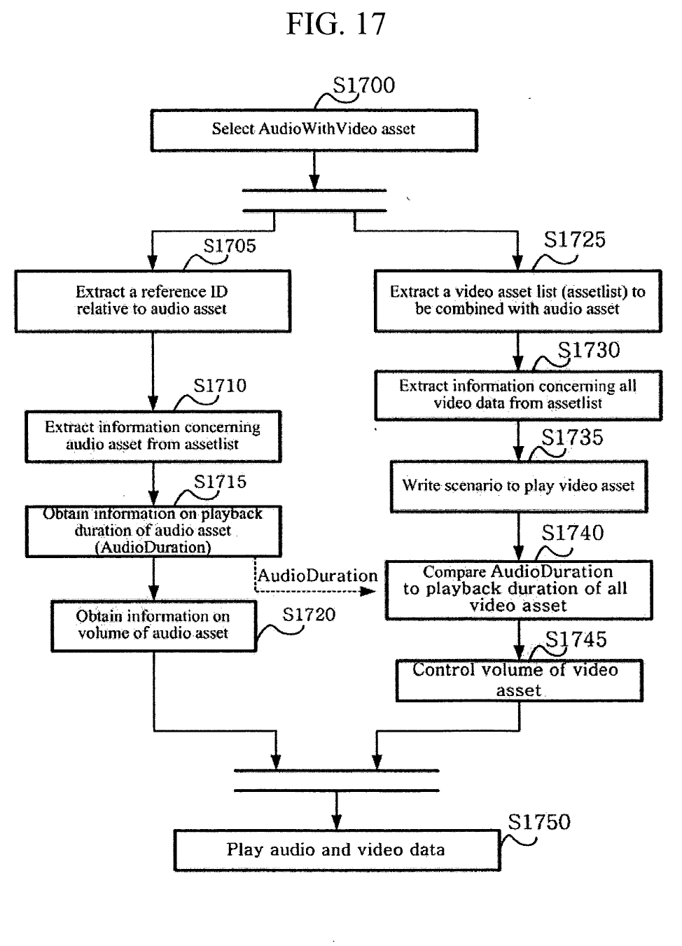

FIG. 17 is a flow chart illustrating a process of playing the ‘AudioWithVideo’ asset according to an aspect of the present invention.

A user executes the software capable of executing any file written according to the MPV format and selects ‘AudioWithVideo’ asset in a certain album S1700. Then, a thread or a child processor is generated, which collects information on audio assets and video assets.

Reference information concerning audio asset constituting the ‘AudioWithVideo’ asset selected by the user is extracted S1705. And information on the audio asset is extracted by use of the reference information from an assetlist S1710. At this time, information on playback time and information on volume of the audio asset are obtained S1715 and S1720.

On the other hand, another thread or a child processor extracts a video assetlist to be combined with the audio asset S1725 and information on all of the video assets from the asset list S1730. Then, either of them determines a scenario to play the video assets using the information, that is, the sequence of the respective video data and time for playing the respective video data S1735. Even though scenarios with respect to all of the video assets to be combined with the audio asset in the step S1735 are determined, the total playback time of all of the video assets may be longer than the playback time of the audio asset. In this case, the total playback time of the video assets is adapted to the playback time of the audio asset. At this time, the playback time information obtained in the step S1715 is used in S1740. Accordingly, a part of the video assets to be played may not be played after the playback time of the audio asset has ended. After completion of the step S1740, the volume generated from the respective video data is adjusted S1745.

After the audio asset and the video assets constituting the ‘AudioWithVideo’ asset are obtained to display the ‘AudioWithVideo’ asset, contents to represent the ‘AudioWithVideo’ asset using the information is played S1750.

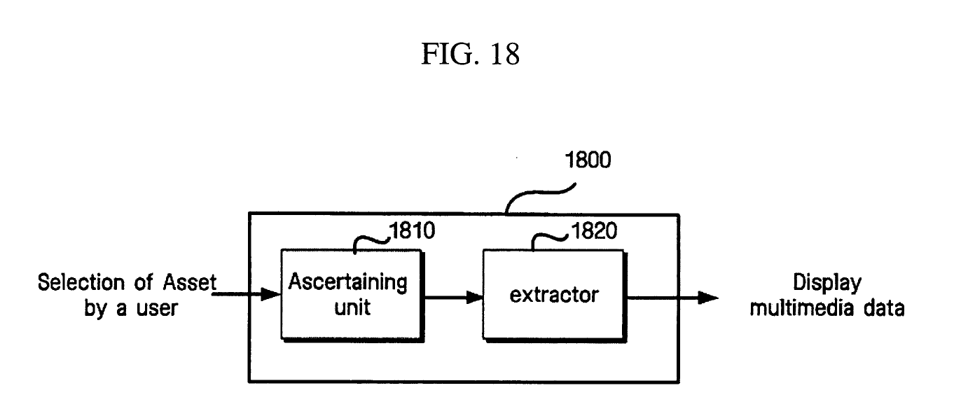

FIG. 18 illustrates an exemplary embodiment of an apparatus for performing a process of displaying audio and video data such as, for example, the process shown in FIG. 17. The apparatus 1800 shown in FIG. 18 includes an ascertaining unit 1810 and an extractor 1820. The ascertaining unit 1810 receives an input by a user and ascertains whether an asset selected by the user includes audio and video data. The extractor 1820 then extracts reference information to display the audio and video data, outputs the extracted audio data using the reference information, extracts the video data from the reference information, and displays the video data while the audio data is being output. The video data can be sequentially displayed according to a predetermined method.

Multimedia data provided in MPV format can be described in the form of XML documents, which can be changed to a plurality of application documents according to stylesheets applied to the XML documents. In the present invention, the stylesheets to change an XML document to an HTML document has been applied, whereby a user is allowed to manage audio and video data through a browser. In addition, the stylesheets to change the XML document to a WML (Wireless Markup Language) or cHTML (Compact HTML) document may be applied, thereby allowing the user to access audio and video data described in the MPV format through mobile terminals such as a personal digital assistant (PDA), a cellular phone, a smart phone and so on.

As described above, the present invention provides users with a new form of multimedia data assets in combination with audio data and video data, thereby allowing the users to generate and use more various multimedia data described in the MPV format.

Although the present invention has been described in connection with the exemplaryembodiments thereof shown in the accompanying drawings, the drawings are mere examples of the present invention. It can also be understood by those skilled in the art that various changes, modifications and equivalents thereof can be made thereto. Accordingly, the true technical scope of the present invention should be defined by the appended claims.

1. An apparatus for displaying audio and video data constituting multimedia data described in multiphoto video (MPV) format, said apparatus comprising:
an ascertaining unit that ascertains whether an asset selected by a user comprises a single audio data and at least one piece of video data,
an extractor that extracts reference information to display the audio data and the at least one video data and then outputs the extracted audio data, using the reference information, and extracts said at least one video data from the reference information and then sequentially displays said at least one video data according to a predetermined method while the audio data is being output.

2. The apparatus as claimed in claim 1, wherein the predetermined method allows the at least one video data to be displayed according to information on display time, to determine playback times of respective video data while the audio data is being output and information on volume control to adjust volume generated when the audio data and the at least one video data are being played.

3. An apparatus for displaying audio and video data constituting multimedia data described in multiphoto video (MPV) format, said apparatus comprising:
an ascertaining unit that ascertains whether an asset selected by a user comprises a single video data and at least one piece of audio data,
an extractor that extracts reference information to display the video data and the at least one piece of audio data and then displays the video data extracted, using the reference information, and extracts the at least one audio data from the reference information and then sequentially outputs said at least one piece of audio data according to a predetermined method while the video data is being displayed.

4. The apparatus as claimed in claim 3, wherein the predetermined method allows the at least one piece of audio data to be displayed according to information on display time, to determine the playback times of respective audio data while the video data is being displayed and information on volume control to adjust volume generated when the at least one piece of audio data is being played.

5. A method for displaying audio and video data constituting multimedia data described in multiphoto video (MPV) format, comprising:
(a) ascertaining whether an asset selected by a user comprises a single audio data and at least one piece of video data;
(b) extracting reference information to display the audio data and the at least one piece of video data;
(c) extracting and displaying the audio data using the reference information; and
(d) extracting and sequentially displaying said at least one piece of video data from the reference information according to a predetermined method while the audio data is being output.

6. The method as claimed in claim 5, wherein the predetermined method allows the at least one piece of video data to be displayed according to information on display time, to determine the playback times of respective video data while the audio data is being output and information on volume control to adjust volume generated when the audio data and the at least one piece of video data is being played.

7. The method as claimed in claim 6, wherein the display time information comprises information on a start time when the at least one piece of video data starts to be played’ and information on playback time to indicate the playback time of the at least one piece of video data.

8. The method as claimed in claim 5, wherein the step (d) comprises:
synchronizing first time information to designate the time for playing the audio data and second time information to designate the time for playing the at least one piece of video data;
extracting first volume control information to adjust a first volume generated while the audio data is being played and second volume control information to adjust a second volume while the at least one piece of video data are being displayed; and
supplying the audio data and the at least one piece of video data through a display medium using the time information and the volume control information.

9. A method for displaying audio and video data constituting multimedia data described in multiphoto video (MPV) format, comprising:
(a) ascertaining whether an asset selected by a user comprises a single video data and at least one piece of audio data;
(b) extracting reference information to display the video data and the at least one piece of audio data;
(c) extracting and displaying the video data using the reference information; and
(d) extracting and sequentially displaying said at least one piece of audio data from the reference information according to a predetermined method while the video data is being displayed.

10. The method as claimed in claim 9, wherein the predetermined method allows the at least one piece of audio data to be displayed according to information on display time, to determine the playback times of respective audio data while the video data is being displayed and information on volume control to adjust volume generated when the video data and the at least one piece of audio data are being played.

11. The method as claimed in claim 10, wherein the display time information comprises information on a start time when the at least one piece of audio data starts to be played’ and information on playback time to indicate the playback time of the at least one piece of audio data.

12. The method as claimed in claim 9, wherein the step (b) comprises:
synchronizing first time information to designate the time for playing video data and second time information to designate the time for playing the at least one piece of audio data;
extracting first volume control information to adjust a first volume generated while the video data is being played and second volume control information to adjust a second volume while the at least one piece of audio data are being displayed; and
supplying the video data and the audio data through a display medium using the time information and the volume control information.

13. A storage medium comprising a recordable medium operable to record thereon a program for displaying multimedia data described in multiphoto video (MPV) format, wherein the program ascertains whether an asset selected by a user comprises a single audio data and at least one piece of video data, extracts reference information to display the audio data and the at least one piece of video data and then displays the audio data extracted, using the reference information, and extracts at least one piece of video data from the reference information and then displays the at least one piece of video data sequentially according to a predetermined method while the audio data is being output.

14. A storage medium comprising a recordable medium operable to record thereon a program for displaying multimedia data described in multiphoto video (MPV) format, wherein the program ascertains whether an asset selected by a user comprises a single video data and at least one piece of audio data, extracts reference information to display the video data and the at least one audio data and then displays the video data extracted, using the reference information, and extracts at least one piece of audio data from the reference information and then sequentially display the at least one piece of audio data according to a predetermined method while the video data is being displayed.
